(19) United States
(12) Patent Application Publication
(10) Pub. No.: US 2008/0153442 A1
(43) Pub. Date: Jun. 26, 2008

(54) APPARATUS AND METHOD FOR DISPLAYING MULTI-POINT COMMUNICATION INFORMATION

(75) Inventor: Ga-Lane Chen, Santa Clara, CA (US)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/734,995

(22) Filed: Apr. 13, 2007

(30) Foreign Application Priority Data
Dec. 26, 2006 (CN) 200610201411.2

(51) Int. Cl. H04B 1/18

(52) U.S. Cl. 455/187.1

(57) ABSTRACT

An exemplary apparatus and an exemplary method for displaying multipoint communication information are provided. In the method, video information from multi-point mobile video communication terminals in a multi-point video communications are displayed in a number of windows on a display screen simultaneously. The window associated with one of the remote mobile video communication terminals will be displayed in a highlighted manner, at occurrence of the decoded signal of the one remote mobile video communication terminal containing audio information. Participants of the multi-point video communications can see all the other participants clearly and hear who is speaking simultaneously.

### BACKGROUND

1. Technical Field

The present invention relates generally to an apparatus for displaying multipoint communication information, more particularly to a mobile video communication terminal for displaying multi-point communication information from a multi-point video communication, and a method for displaying multi-point communication information from the multi-point video communication.

2. Description of Related Art

H.323 is a part of H.32x series of protocol standards defined by International Telecommunications Union Telecommunication Standardization Sector (ITU-T). H.32x series of protocol standards address communications over narrow integrated services digital network (also known by the acronym N-ISDN), broadband integrated services digital network (B-ISDN), general switched telephone network (GSTN), and so on.

H.323 defines protocol standards to provide voice applications and mechanisms for video communication and data collaboration on any packet-based network (PBN). H.323 is commonly used in voice over internet protocol (VoIP) and internet protocol (IP)-based videoconferencing. The components under H.323 architecture are terminals, a gateway, a gatekeeper and a multipoint control unit (MCU). A terminal can provide real-time and bidirectional communications with another H.323 terminal, gateway or MCU. The comments of communications consist of audio information, video information and a combination of audio information and video information. On the base of H.323 protocol standards, multi-point videoconferences could be implemented over current telecommunication networks. A multi-point videoconference is one kind of communication between two or more people who are at different sites but can see and hear each other using telecommunication.

A typical mobile video communication terminal generally can display video information from two terminals joined in communication. Signals from the two terminals are transmitted in separate video channels. Video information of the signals in the different video channels can be displayed in foreground and background form by setting differing parameters of the video channels, thereby displaying video information of the two terminals in communication simultaneously. However, it is difficult to distinguish the signals from different terminals so as to correctly set parameters of the video channels in communication. Therefore, such typical mobile video communication terminal is not suitable for the multi-point video communication, and cannot display multi-point communication video information from multiple terminals in communication.

What is needed, therefore, is an apparatus for displaying multipoint communication information from a multi-point video communication and a method for displaying multi-point communication information from the multi-point video communication.

### SUMMARY

One preferred embodiment provides a method for displaying multi-point communication information on a display screen of a local mobile video communication terminal. In the method, a plurality of windows (i.e., sections of screen in which different sources of information are displayed) are displayed on the display screen of the local mobile video communication terminal, each of the plurality of windows being configured for displaying information associated with its respective remote mobile video communication terminals. A signal transmitted from each of the remote mobile video communication terminals is decoded using a multiplex decoding unit of the local mobile video communication terminal. A central processing unit of the local mobile video communication terminal then judges whether the decoded signal of each of the remote mobile video communication terminals contains audio information. When the decoded signal from one of remote mobile video communication terminals is judged to contain audio information, a window associated with the remote mobile video communication terminal containing audio information is displayed on the display screen in a highlighted manner (for example, by displaying it in a flashing box).

Another preferred embodiment provides a mobile video communication terminal capable of displaying multi-point communication information from a multi-point video communication. The mobile video communication terminal includes a signal unit, a multiplex decoding unit, a central processing unit and a display screen. The signal unit is configured for receiving a signal from one of remote mobile video communication terminals. The multiplex decoding unit is configured for decoding a signal transmitted from each of the remote mobile video communication terminals. The central processing unit is configured for judging whether the decoded signal of each of the remote mobile video communication terminals contains audio information. The display screen is configured for displaying a number of windows thereon, each of the windows being configured for displaying information associated with its respective remote mobile video communication terminals.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a functional block diagram of a mobile video communication terminal according to an exemplary embodiment;

FIG. 2 is a schematic view of a display screen of the mobile video communication terminal according to the exemplary embodiment;

FIG. 3 is a flow-chart of a method for displaying multi-point communication information according to the exemplary embodiment;

FIG. 4 is a schematic view of a display screen for displaying multi-point communication information according to the exemplary embodiment;

FIG. 5 is another schematic view of a display screen for displaying multi-point communication information according to the exemplary embodiment; and

FIG. 6 is further another schematic view of a display screen for displaying multi-point communication information according to the exemplary embodiment.

### DETAILED DESCRIPTION OF THE EMBODIMENTS

Embodiments will now be described in detail below and with reference to the drawings.

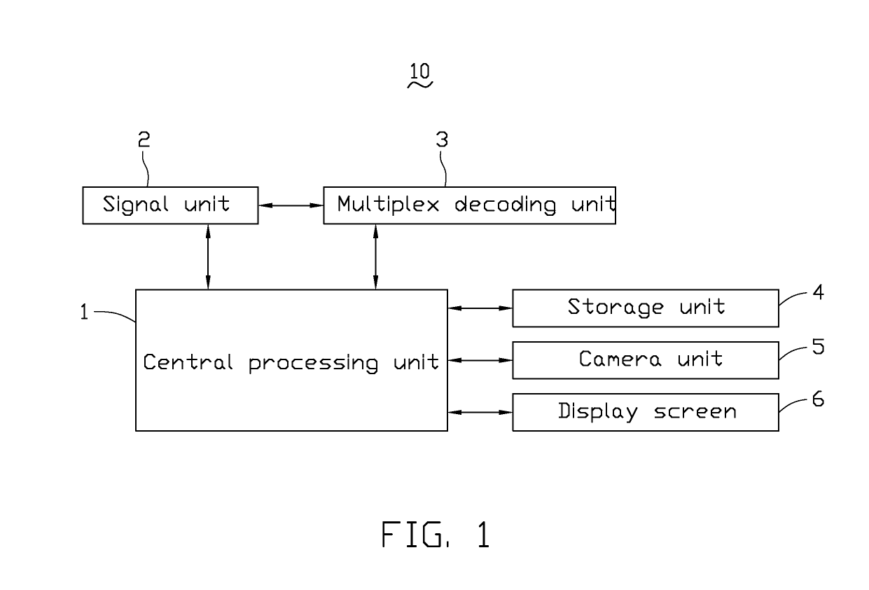

Referring to FIG. 1, a mobile video communication terminal 10 includes a central processing unit 1, a signal unit 2, a multiplex decoding unit 3, a storage unit 4, a camera unit 4, and a display screen 6. The central processing unit (CPU) 1 connects with the signal unit 2, the multiplex decoding unit 3, the storage unit 4, the camera unit 4 and the display screen 6. The CPU 1 is configured (i.e., structured and arranged) for controlling the signal unit 2, the multiplex decoding unit 3, the storage unit 4, the camera unit 4 and the display screen 6. The CPU 1 is also configured for judging a decoded signal. The signal unit 2 suitably includes an antenna, a signal receiving and sending device, and a modem device (not shown). The signal unit 2 is configured for sending a signal and receiving a signal. The multiplex decoding unit 3 is configured for decoding the signal. The multiplex decoding unit 3 can transform the signal received by the signal unit 2 into a certain format for displaying. The storage unit 4 can be random access memory (RAM), hard disk drive (HDD), flash memory. The storage unit 4 is configured for storing information such as video recordings. The camera unit 4 can be a camera module, and is configured for recording video information.

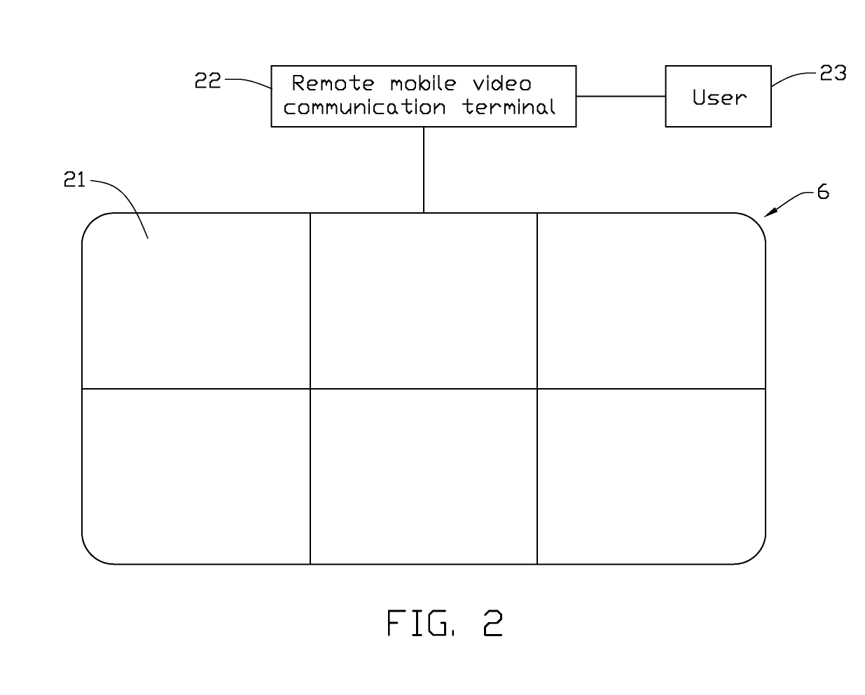

The display screen 6 is configured for displaying multi-point communication information thereon under the control of the CPU 1. The display screen 6 advantageously is a liquid crystal display (LCD) device. Referring to FIG. 2, the display screen 6 is shown. The display screen 6 can display a number of windows 21 thereon. In the illustrated embodiment, the display screen 6 displays six windows 21.

The mobile video communication terminal 10 can be used in multi-point video communication. After a connection of a multi-point video communication between a local mobile video communication terminal and a number of remote mobile video communication terminals is established, the CPU 1 of the local mobile video communication terminal instructs the signal unit 2 of the local mobile video communication terminal to send a signal to the remote mobile video communication terminals and to receive a signal from each of the remote mobile video communication terminals. Meanwhile, the CPU 1 instructs the multiplex decoding unit 3 to decode the signals received. Because each window 21 is associated with one of the remote mobile video communication terminals, video information transmitted from each of remote mobile video communication terminals can be displayed in the corresponding window 21. In the illustrated embodiment, one window 21 associated with a remote mobile video communication terminal 22 is used by a user 23 to display information. Thus, video information transmitted from the remote mobile video communication terminal 22 can be displayed in its corresponding window 21. Furthermore, if the remote mobile video communication terminal 22 sends audio information, the window 21 associated with the remote mobile video communication terminal 22 will be displayed in a highlighted manner. Therefore, users of the local mobile video communication terminal can know the status of all remote participants of the multi-point video communication.

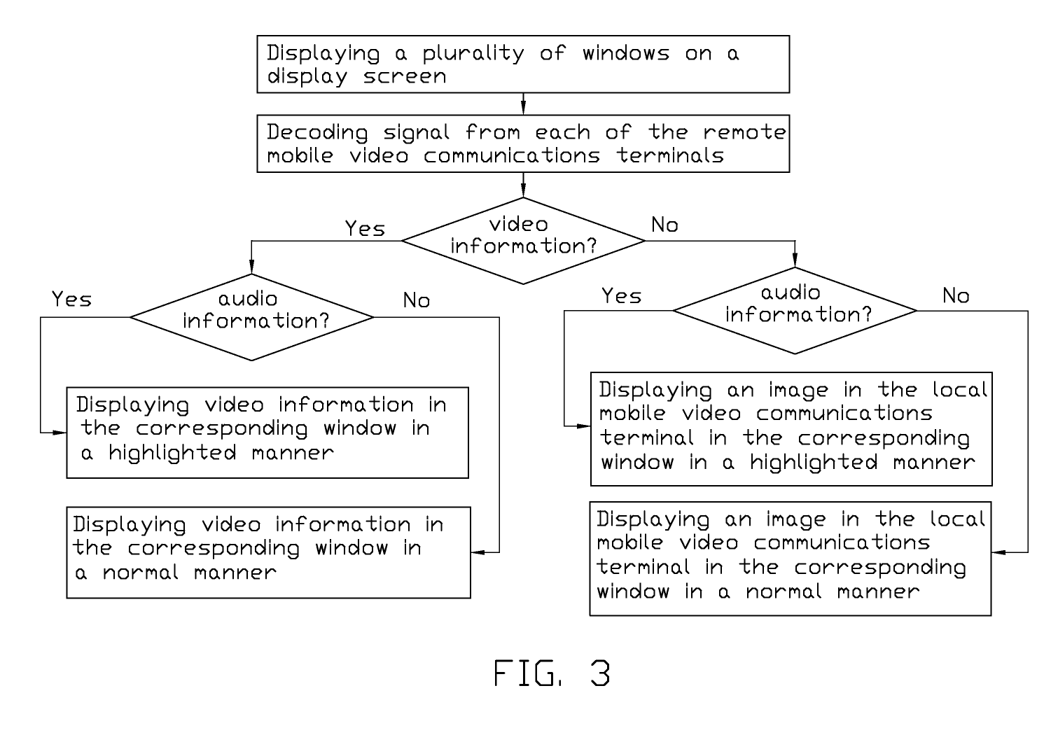

Referring to FIG. 2 and FIG. 3, a method for displaying multi-point communication information in a multi-point video communication between a local mobile video communication terminal and a number of remote mobile video communication terminals is illustrated.

Firstly, the display screen 6 of the local mobile video communication terminal displays a number of windows 21 thereon. The windows 21 are configured for displaying multi-point communication information. Each window 21 is associated with one of the remote mobile video communication terminals in the multi-point video communication. The CPU 1 can give an instruction to MCU to inquire the number of the remote mobile video communication terminals. The display screen 6 can display windows 21 thereon according to the number received.

Secondly, the multiplex decoding unit 3 of the local mobile video communication terminal decodes a signal transmitted from each of the remote mobile video communication terminals in the multi-point video communication. The multiplex decoding unit 3 can transform the signal transmitted from each of the remote mobile video communication terminals into a certain format for displaying.

Thirdly, the CPU 1 of the local mobile video communication terminal judges whether the decoded signal of each of the remote mobile video communication terminals includes audio information. At first, the CPU 1 judges whether the decoded signal of each of the remote mobile video communication terminals includes video information, and then it judges whether the decoded signal of each of the remote mobile video communication terminals includes audio information.

If the decoded signal of one remote mobile video communication terminal includes video information, the CPU 1 will then judge whether the decoded signal includes audio information. If the decoded signal includes audio information (i.e., the decoded signal includes both audio information and video information), video information will be displayed in the window 21 associated with the corresponding remote mobile video communication terminal. The window 21 associated with the one remote mobile video communication terminal can display video information in various highlighted manners. The window 21 can be framed or can flash. Color of a background of the window 21 can change. An icon can be displayed in the window 21 and a size of the window 21 can be changed. For example, the window 21 can be enlarged gradually and video information of the window 21 can be displayed full screen.

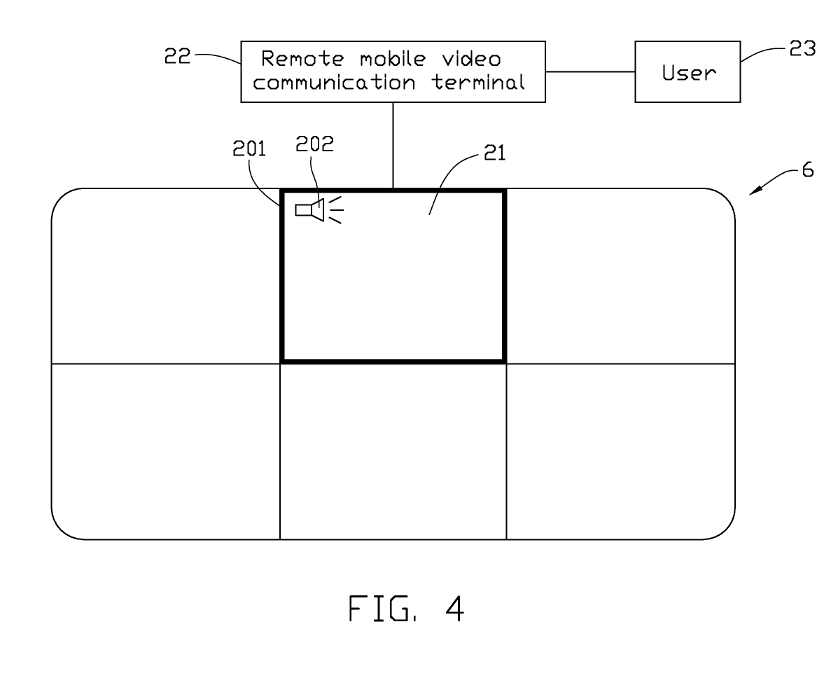

Referring to FIG. 4, in the embodiment, when the remote user 23 is speaking using the remote mobile video communication terminal 22 in multi-point video communication, the decoded signal of the remote mobile video communication terminal 22 includes video information and audio information. Therefore, the window 21 associated with the remote mobile video communication terminal 22 that is used by the user 23 displays video information with a highlighted frame 201. Additionally, the window 21 associated with the remote mobile video communication terminal 22 that is used by the user 23 is marked with a speaking icon 202.

If the decoded signal of the one remote mobile video communication terminal doesn't include audio information (i.e., the decoded signal includes no audio information but does include video information), video information will be displayed in the window 21 associated with the one remote mobile video communication terminal. The window 21 displaying video information is displayed in a normal manner. The window 21 only displays video information of the one remote mobile video communication terminal without any highlighted features.

If the decoded signal of the one remote mobile video communication terminal doesn't include video information, the CPU 1 will still judge whether the decoded signal includes audio information. If the decoded signal includes audio information (i.e., the decoded signal includes no video information but does include audio information), an image in the local mobile video communication terminal will be displayed in the window 21 associated with the one remote mobile video communication terminal. The window 21 associated with the one remote mobile video communication terminal can display the image in various highlighted manners. The window 21 can be framed or can flash. Color of a background of the window 21 can change. An icon can be displayed in the window 21 and a size of the window 21 can be changed. For example, the window 21 can be enlarged gradually and the image of the window 21 can be displayed full screen. The image can be still pictures, motion pictures, or video icons.

If the decoded signal of the one remote mobile video communication terminal doesn't include audio information (i.e., the decoded signal include neither video information nor audio information), the image in the local mobile video communication terminal will be displayed in the window 21 associated with the one remote mobile video communication terminal. The window 21 displaying the image is displayed in a normal manner. The window 21 only displays the image in the local mobile video communication terminal without any highlighted features.

Accordingly, depending on whether the decoded signal of each of the remote mobile video communication terminals includes video information and audio information, the window associated with one of the remote mobile video communication terminals will be displayed in a highlighted manner.

Multi-point communication information can be displayed in the windows 21 simultaneously in two modes. One is a combined mode. The CPU 1 processes multi-point communication video information and combines multi-point communication video information into a single video image to display in the display screen 6. The other is a separation mode. Each window 21 includes a video player for displaying corresponding video information. The multiplex decoding unit 3 must be capable of decoding multi-point communication signals in both the combination mode and the separation mode.

The mobile video communication terminal 10 can display video information of multi-point mobile video communication terminals simultaneously in the multi-point video communication by using the method described above. Participants of the multi-point video communication can see all the remote participants clearly and hear who is speaking.

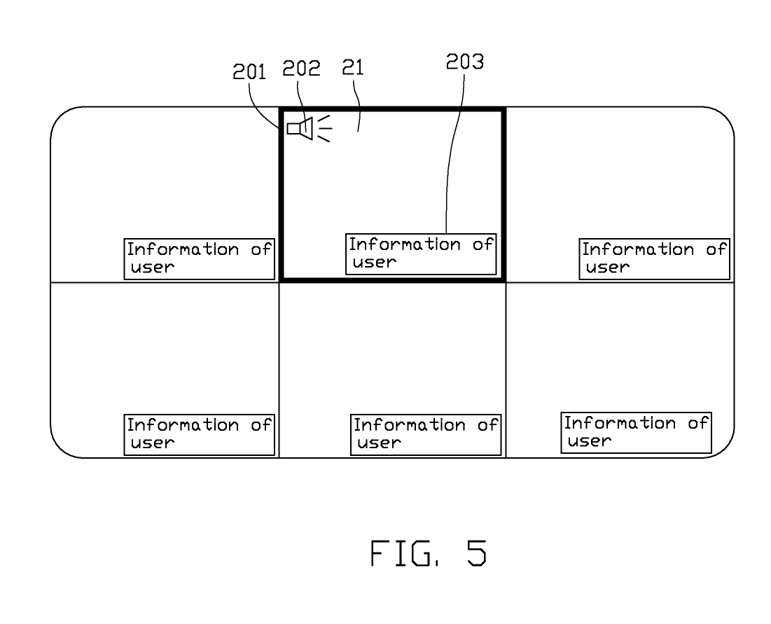

Preferably, referring to FIG. 5, information of each user 203 such as name and position can be displayed in the corresponding window 21. The information can be obtained from a database of the local mobile video communication terminal.

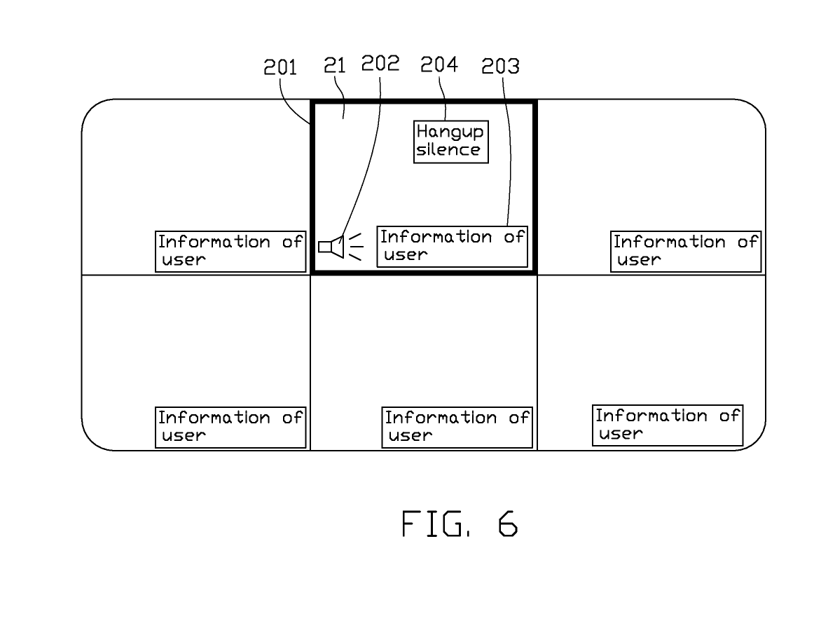

Preferably, referring to FIG. 6, a menu 204 can be displayed in each window 21. The menu 204 can be displayed directly in the corresponding window 21 or hidden. The user can make the menu 204 to be displayed by pressing some key or touching the display screen 6. The menu 204 can include different options for different users. For example, for a controller of the multi-point video communication, the options can be “request speech”, “hang-up”, “allow speech”, “silence” and “exit”. For a common participant of the multi-point video communication, the options can be “request speech” and “exit”. In the illustrated embodiment, the menu 204 includes two options, “hang-up” and “silence”. The menu 204 can further facilitate the control of the multi-point video communication.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A method for displaying multi-point communication information on a display screen of a local mobile video communication terminal, comprising:
displaying a plurality of windows on the display screen of the local mobile video communication terminal, each of the plurality of windows being configured for displaying information associated with its respective remote mobile video communication terminal;
decoding a signal transmitted from each of the remote mobile video communication terminals using a multiplex decoding unit of the local mobile video communication terminal;
judging whether the decoded signal of each of the remote mobile video communication terminals contains audio information using a central processing unit (CPU) of the local mobile video communication terminal; and
at occurrence of the decoded signal from one of the remote mobile video communication terminals containing audio information displaying the window associated with the one remote mobile video communication terminals containing audio information in a highlighted manner.

2. The method as claimed in claim 1, wherein the judging step comprises judging whether the decoded signal from each of the remote mobile video communication terminals contains video information; and judging whether the decoded signal from each of the remote mobile video communication terminals contains audio information when it has been judged that the decoded signal contains video information.

3. The method as claimed in claim 2, wherein in the step of displaying the window associated with the remote mobile video communication terminals, if the decoded signal from the one remote mobile video communication terminal contains both video and audio information, video information is displayed in the window associated with the corresponding remote mobile video communication terminal in a highlighted manner.

4. The method as claimed in claim 3, further comprising the step of displaying video information in the window associated with the corresponding remote mobile video communication terminal in a normal manner, if the decoded signal from the one remote mobile video communication terminal contains no audio information but does contain video information.

5. The method as claimed in claim 4, further comprising the step of displaying an image on the display screen of the local mobile video communication terminal in the window associated with the corresponding remote mobile video communication terminal in a highlighted manner if the decoded signal of the one remote mobile video communication terminal contains no video information but does contain audio information.

6. The method as claimed in claim 5, further comprising the step of displaying an image on the display screen of the local mobile video communication terminal in the window associated with the corresponding remote mobile video communication terminal in a normal manner if the decoded signal from the one remote mobile video communication terminal contains neither video information nor audio information.

7. The method as claimed in claim 6, wherein the window is displayed in a highlighted manner by means selected from a group consisting of framing the window, making the window flash, changing color of a background of the window, changing a size of the window, and displaying an icon in the window.

8. The method as claimed in claim 6, wherein the image displayed on the display screen of the local mobile video communication terminal is selected from a group consisting of still pictures, motion pictures and video icons.

9. The method as claimed in claim 6, wherein information of a user of each of the remote mobile video communication terminals is displayed in the corresponding window.

10. The method as claimed in claim 6, wherein a menu is displayed in each window corresponding to each of the remote mobile video communication terminals.

11. An apparatus for displaying multipoint communication information, comprising:
a signal receiving unit, for receiving a signal from one of remote mobile video communication terminals;
a multiplex decoding unit, for decoding a signal transmitted from each of the remote mobile video communication terminals;
a CPU, for judging whether the decoded signal of each of the remote mobile video communication terminals contains audio information; and
a display screen, for displaying a plurality of windows thereon, each of the plurality of windows being configured for displaying information associated with its respective remote mobile video communication terminals.

12. The apparatus for displaying multipoint communication information as claimed in claim 11, further comprising a storage unit configured for storing the image therein.

13. The apparatus for displaying multipoint communication information as claimed in claim 12, further comprising a camera unit configured for recording video information.

14. The apparatus for displaying multipoint communication information as claimed in claim 11, wherein the window is displayed in a highlighted manner by means selected from a group consisting of framing the window, making the window flash, changing color of a background of the window, changing a size of the window, and displaying an icon in the window.

15. The apparatus for displaying multipoint communication information as claimed in claim 11, wherein the image displayed on the display screen of the local mobile video communication terminal is selected from a group consisting of still pictures, motion pictures and video icons.

16. The apparatus for displaying multipoint communication information as claimed in claim 11, wherein information of a user of each of the remote mobile video communication terminal is displayed in the corresponding window.

17. The apparatus for displaying multipoint communication information as claimed in claim 11, wherein a menu is displayed in each window corresponding to each of the remote mobile video communication terminals.
